(19) United States
(12) Patent Application Publication
(10) Pub. No.: US 2021/0354587 A1
(43) Pub. Date: Nov. 18, 2021

(54) CONTROL APPARATUS FOR ELECTRIC VEHICLE

(71) Applicant: DENSO CORPORATION, Kariya-city (JP)

(72) Inventors: Akihiro IMURA, Kariya-city (JP); Mitsuharu HIGASHITANI, Kariya-city (JP)

(73) Assignee: DENSO CORPORATION, Kariya-city (JP)

(21) Appl. No.: 17/319,682

(22) Filed: May 13, 2021

(30) Foreign Application Priority Data
May 13, 2020 (JP) 2020-084739

(51) Int. Cl. B60L 58/13; B60Q 9/00; B60L 1/00

(52) U.S. Cl. CPC B60L 58/13; B60L 1/00; B60Q 9/00

(57) ABSTRACT

In a control apparatus for an electric vehicle driven by an electric motor being actuated based on electric power supplied from a battery, a predictor is configured to calculate a predicted amount of remaining power of the battery that will remain on arrival of the vehicle at a destination. A notification controller is configured to cause a notifier to provide a notification based on the predicted amount of remaining power of the battery.

### CROSS-REFERENCE TO RELATED APPLICATION

This application is based on and claims the benefit of priority from earlier Japanese patent application no. 2020-084739 filed on May 13, 2020, the description of which is incorporated herein by reference.

### BACKGROUND

### Technical Field

This disclosure relates to a control apparatus for an electric vehicle.

### Related Art

One conventional control apparatus for a vehicle is known that includes a schedule acquirer, a destination predictor, a travel planner, and a power generation controller. The schedule acquirer acquires a schedule of an occupant of the vehicle. Based on past and future schedules and date and time information acquired by the schedule acquirer, the destination predictor predicts a future destination including a destination that is not registered in the schedules. The travel planner generates travel plan information indicating a travel plan of the vehicle for the future schedule in response to a route to the destination predicted by the destination predictor. The power generation controller controls a generator according to the future schedule based on the travel plan information generated by the travel planner.

### BRIEF DESCRIPTION OF THE DRAWINGS

In the accompanying drawings:

FIG. 1 is a schematic block diagram of an electric vehicle according to a first embodiment;

FIG. 2 is a flowchart of process steps performed by a prediction ECU according to the first embodiment;

FIG. 3 is a schematic block diagram of an electric vehicle according to a second embodiment; and

FIG. 4 is a flowchart of process steps performed by a prediction ECU according to the second embodiment.

### DESCRIPTION OF SPECIFIC EMBODIMENTS

An electric vehicle having an autonomous driving function is used by a user as a means of transportation to a destination. More specifically, such an electric vehicle may be used as an anteroom until arriving at the destination. Specific usage includes watching movies using a video player installed in the vehicle, trimming hair using a dryer, heating coffee using a heater, and the like, depending on the user's taste. In order to use these appliances in the electric vehicle, it is necessary to ensure that a battery mounted to the electric vehicle has enough power to actuate these appliances. In this point, the known control apparatus, as disclosed in JP-A-2019-131112, controls the generator based only on the travel plan of the vehicle. However, for example, in cases where the user uses the appliances for a long time, the vehicle may be unable to reach the destination due to battery power exhaustion.

Such an issue is common not only with electric vehicles having an autonomous driving function but also with electric vehicles having no autonomous driving function.

In view of the foregoing, it is desired to have an apparatus for controlling an electric vehicle, which allows the electric vehicle to more reliably arrive at a destination while it is possible to use appliances.

One aspect of the present disclosure provides a control apparatus for an electric vehicle driven by an electric motor being actuated based on electric power supplied from a battery. In the control apparatus, a predictor is configured to calculate a predicted amount of remaining power of the battery that will remain on arrival of the vehicle at a destination. A notification controller is configured to cause a notifier to provide a notification based on the predicted amount of remaining power of the battery.

This configuration allows a user of the electric vehicle to determine, from the notification provided by the notifier, whether there is a sufficient amount of remaining power of the battery at the time when the vehicle reaches the destination. If it is determined that there is a sufficient amount of remaining power of the battery, the user is allowed to use appliances that are used for non-traveling purposes, that is, for purposes other than driving the vehicle. If it is determined that there is not a sufficient amount of remaining power of the battery, the user will withhold using the appliances. Therefore, a situation is less likely to occur where the remaining power of the battery becomes exhausted before the vehicle reaches the destination. This allows the vehicle to more reliably reach the destination while the appliances can be used.

Hereinafter, an apparatus for controlling an electric vehicle according to one embodiment will be described with reference to the accompanying drawings. To facilitate understanding, identical reference numerals have been used, where possible, to designate identical elements that are common to the figures. Duplicated description thereof will be omitted.

### FIRST EMBODIMENT

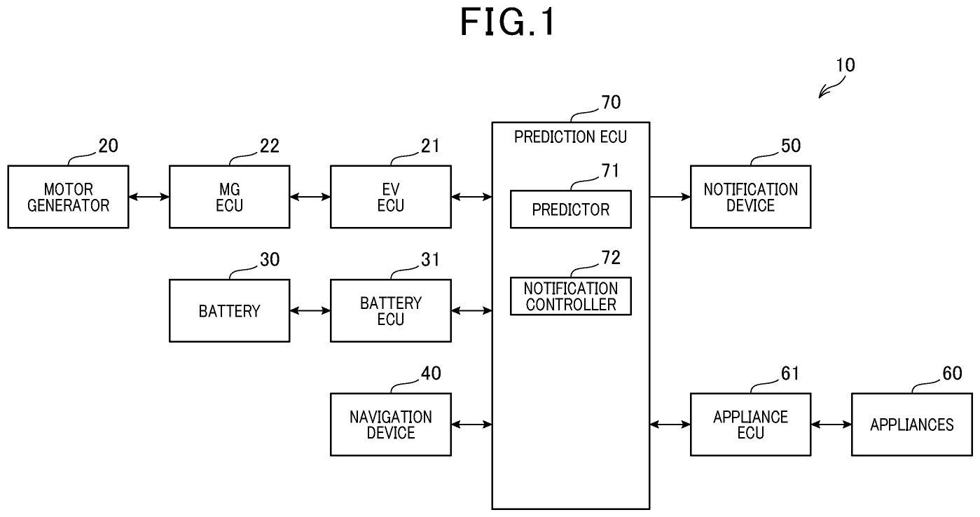

A schematic configuration of a vehicle 10 will now be described with reference to FIG. 1. The vehicle 10 illustrated in FIG. 1 is an electric vehicle that is driven by a motor generator 20 as a power source. The vehicle 10 includes a battery 30, a navigation device 40, a notification device 50, and appliances 60.

The battery 30 is a secondary battery, such as a rechargeable lithium-ion battery or the like.

The motor generator 20 is driven by electric power supplied from the battery 30 via an inverter device (not illustrated). Outputs from the motor generator 20 driven are transferred to wheels of the vehicle 10 via a transmission mechanism or the like, which causes the vehicle 10 to travel. During deceleration of the electric vehicle 10, the motor generator 20 regenerates electric power based on forces transferred from the wheels to the motor generator 20. The electric power regenerated by the motor generator 20 is supplied to charge the battery 30 via the inverter device. In the present embodiment, the motor generator 20 corresponds to an electric motor.

The navigation device 40 guides a travel path of the vehicle 10 for a driver. For example, given a destination set by the driver, the navigation device 40 sets a travel route of the vehicle 10 from the current location to the destination, and displays the travel route or provides an audio notification of the travel route to the driver. The navigation device 40 has prestored therein map information, road information and the like.

The notification device 50 provides various notifications to a user or users of the vehicle 10. The notification device 50 may include a display device that provides notifications by displaying images, a speaker device that provides audio notifications, and other types of devices. The notification device 50 may divert the display function or audio function of the navigation device 40. In the present embodiment, the notification device 50 corresponds to a notifier.

The appliances 60 refer to various appliances used by the user in the vehicle 10 depending on the user's taste. The appliances 60 are actuated by electric power supplied from the battery 30 and may include, for example, a video player for watching movies, a dryer for trimming hair, a heater for heating coffee. The appliances 60 may further include a mobile terminal, such as a smartphone or the like in user's possession, a refrigerator, a microwave, or others. The appliances 60 include not only appliances previously installed in the vehicle 10, but also appliances that the user brought into the vehicle 10. The appliances that the user brought into the vehicle 10 can be used by being plugged into an electric outlet provided in the vehicle 10. In the present embodiment, the appliances 60 correspond to appliances that are used for non-traveling purposes, that is, for purposes other than driving the vehicle 10 or causing the vehicle 10 to travel or move.

The vehicle 10 includes an electric vehicle (EV) ECU 21, a motor generator (MG) ECU 22, a battery ECU 31, an appliance ECU 61, and a prediction ECU 70. “ECU” is an abbreviation for electronic control unit. Each of the ECUs 21, 22, 31, 61, 70 is configured around a microcomputer including a central processing unit (CPU) and a read-only memory (ROM), a random-access memory (RAM), a non-volatile memory, and other components. Various functions of each of the ECUs 21, 22, 31, 61, 70 may be implemented by the CPU executing computer programs prestored in the ROM or the like.

The EV ECU 21 is responsible for overall control of the vehicle 10. The EV ECU 21 performs, for example, normal driving control for driving the vehicle 10 in response to operations by the driver and autonomous driving control for autonomous driving of the vehicle 10. During each of the normal driving control and the autonomous driving control, the EV ECU 21 calculates torque command values indicative of torques to be output from the motor generator 20 for accelerating or decelerating the vehicle 10 and transmits the calculated torque command values to the MG ECU 22. The MG ECU 22 controls the motor generator 20 such that the output torque of the motor generator 20 approaches the torque command value.

The MG ECU 22 acquires power consumption information of the motor generator 20 and sequentially transmits the power consumption information to the EV ECU 21. Based on the power consumption information of the motor generator 20 received form the MG ECU 22, the EV ECU 21 calculates a power consumption of the motor generator 20 per unit traveled distance by the vehicle 10 and stores the calculated power consumption of the motor generator 20 per unit traveled distance in the non-volatile memory to make a database. The EV ECU 21 calculates a steady power consumption of the motor generator 20 per unit traveled distance by the vehicle 10 by detecting a steady power consumption that is an amount of power steadily consumed in the vehicle 10, such as a power consumption of accessories of the vehicle 10. The EV ECU 21 stores the steady power consumption of the motor generator 20 per unit traveled distance by the vehicle 10 in the non-volatile memory to make a database.

The battery ECU 31 detects a state of charge (SOC) value of the battery 30 and manages the state of the battery 30 based on the detected SOC value. The SOC value ranges from 0% to 100%. When the battery 30 is fully discharged, the SOC value is 0%. When the battery 30 is fully charged, the SOC value is 100%.

The appliance ECU 61 is responsible for overall control of the appliances 60. In cases where a plurality of appliances 60 are mounted to the vehicle 10, the appliance ECU 61 may be individually provided to the respective appliances 60.

The prediction ECU 70 is communicable with the navigation device 40 and the respective ECUs 21, 31, 61. In the present embodiment, the prediction ECU 70 corresponds to the control apparatus. Based on information acquirable from the navigation device 40 and the respective ECUs 21, 31, 61, the prediction ECU 70 predicts a future course of the amount of power of the battery 30 and causes the notification device 50 to provide various notifications based on the predicted future course of the amount of power of the battery 30.

More specifically, the prediction ECU 70 includes a predictor 71 and a notification controller 72. The predictor 71 calculates a predicted amount of remaining power of the battery 30 that will remain on arrival of the vehicle 10 at the destination set in the navigation device 40. In the present embodiment, the amount of remaining power of the battery 30 corresponds to an amount of remaining energy of the battery 30. The notification controller 72 causes the notification device 50 to provide a notification based on the predicted amount of remaining power of the battery 30 predicted by the predictor 71.

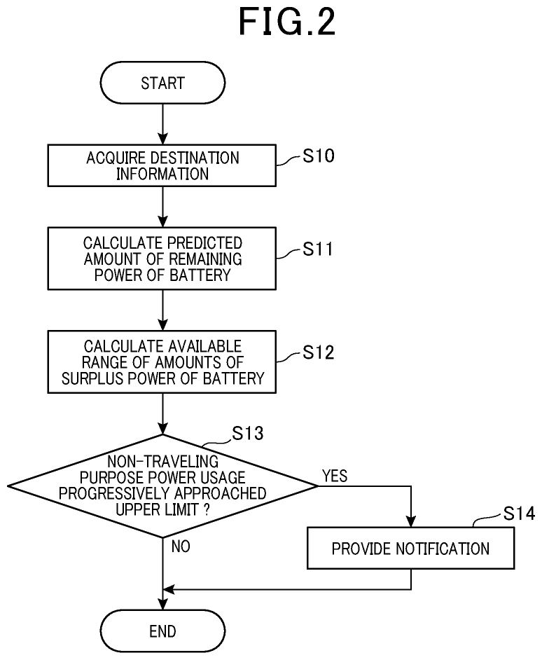

The process steps performed by the prediction ECU 70 will now be described with reference to FIG. 2. More specifically, the process illustrated in FIG. 2 is performed repeatedly by the prediction ECU 70 every predetermine time interval.

As illustrated in FIG. 2, after acquiring destination information of the vehicle 10 from the navigation device 40 at step S10, the predictor 71 of the prediction ECU 70 calculates a predicted amount of remaining power of the battery 30 that will remain on arrival of the vehicle 10 at the destination, that is, at the time when the vehicle 10 reaches the destination.

More specifically, the predictor 71 acquires information of the current value of SOC of the battery 30 from the battery ECU 31. The predictor 71 acquires, from the EV ECU 21, information of a power consumption per unit traveled distance by the motor generator 20 and information of a steady power consumption per unit traveled distance by the vehicle 10. The predictor 71 calculates a predicted traveled distance from the current location to the destination of the vehicle 10 and then calculates a product of the predicted traveled distance and the power consumption per unit traveled distance to thereby calculate a predicted traveling-purpose power usage that is necessary for the vehicle 10 to travel to the destination. The predictor 71 may calculate the predicted traveling-purpose power usage based on a combination of at least two of the traveled distance, the travel resistance, and the air conditioning operation. The predictor 71 further calculates a product of the predicted traveled distance and the steady power consumption per unit traveled distance to thereby calculate a predicted steady power consumption that is necessary for the vehicle 10 to travel to the destination. In the present embodiment, the predicted traveling-purpose power usage corresponds to a predicted amount of traveling-purpose energy, and the predicted steady power consumption corresponds to a predicted steady energy consumption.

The predictor 71 calculates a current amount of charged power in the battery 30 based on the current SOC value of the battery 30 using a calculation formula or the like. The predictor 71 calculates a sum of the predicted traveling purpose power usage and the predicted steady power consumption and subtracts the calculated sum from the current amount of charged power in the battery 30, thereby calculating a predicted amount a of remaining power of the battery 30.

At step S12 subsequent to step S11, the predictor 71 calculates an available range of amounts of surplus power of the battery 30 that is available for non-traveling purposes. For example, the predictor 71 subtracts a predetermined amount a from the predicted amount a of remaining power of the battery 30 to thereby calculate an upper limit β of the available range of amounts of surplus power of the battery 30. The predetermined amount a is set to allow for an amount of power of the battery 30 such that the vehicle 10 can more reliably reach the destination. The predetermined amount a may be pre-stored in the ROM of the prediction ECU 70. The predictor 71, using the upper limit β, sets the available range of amounts of surplus power Wb of the battery 30 such that, for example, 0≤Wb≤β. In the present embodiment, the amount of surplus power of the battery 30 corresponds to surplus energy of the battery 30.

At step S13 subsequent to step S12, the predictor 71 determines whether the non-traveling purpose power usage has progressively approached the upper limit β of the available range of amounts of surplus power of the battery 30. More specifically, the predictor 71 acquires, as the non-traveling purpose power usage, information of a power usage of the appliances 60 from the appliances ECU 61 and then determines whether the power usage of the appliances 60 has reached the upper limit β. In the present embodiment, the power usage of the appliances 60 corresponds to non-traveling purpose energy. If the power usage of the appliances 60 has not yet reached the upper limit β, the predictor 71 determines that the non-traveling purpose power usage has not progressively approached the upper limit β of the available range of amounts of surplus power of the battery 30 and then selects the “NO” branch of step S13. In this case, the process flow illustrated in FIG. 2 ends.

In some other embodiments, at step S13, the predictor 71 may set a threshold that is a predetermined value smaller than the upper limit β and determine whether the power usage of the appliances 60 has reached the threshold.

When the vehicle 10 travels from the current location to the destination, the power usage of the appliances 60 is increased each time the appliances 60 is used by the user. In response to the power usage of the appliances 60 reaching the upper limit β, the predictor 71 determines that the non-traveling purpose power usage has progressively approached the upper limit of the available range amount of surplus power of the battery 30. The process flow then selects the “YES” branch of step S13. In this case, the notification controller 72, at step S14, causes the notification device 50 to provide a notification that the non-traveling purpose power usage has progressively approached the upper limit β. Thereafter, the process flow illustrated in FIG. 2 ends.

The prediction ECU 70 of the vehicle 10 according to the present embodiment can provide the following advantages (1) to (4).

(1) The prediction ECU 70 includes the predictor 71 configured to calculate the predicted amount of remaining power of the battery 30 that will remain on arrival of the vehicle 10 at the destination, and the notification controller 72 configured to cause the notification device 50 to provide a notification based on the predicted amount of remaining power of the battery 30. This configuration allows the user of the vehicle 10 to determine, based on the notification from the notification device 50, whether there is a sufficient amount of remaining power of the battery 30 to use the appliances 60. If it is determined that there is a sufficient amount of remaining power of the battery 30, the user is allowed to freely use the appliances 60. If it is determined that there is not a sufficient amount of remaining power of the battery 30 to use the appliances 60, the user will withhold using the appliances 60 for non-traveling purposes. Therefore, a situation is less likely to occur where the charged power in the battery 30 becomes exhausted before the vehicle 10 reaches the destination. This allows the vehicle 10 to more reliably reach the destination while the appliances 60 can be used.

(2) The predictor 71 is configured to calculate the predicted amount of remaining power of the battery based on the predicted steady power consumption of the vehicle 10 that is a predicted amount of power steadily consumed in the vehicle 10 and the predicted amount of traveling-purpose energy that is required for the vehicle 10 to travel to the destination. Such a configuration allows a predicted amount of remaining power of the battery to be more accurately calculated.

(3) The predictor 71 is configured to calculate the available range of amounts of surplus power of the battery 30 that are available for non-traveling purposes based on the predicted amount of remaining power of the battery 30. This configuration allows the amount of surplus power of the battery 30 to be readily calculated.

(4) The notification controller 72 is configured to, in response to the power usage of the appliances 60 having progressively approached the upper limit of the available range of amounts of surplus power of the battery 30, provide a notification to the user of the vehicle 10. This configuration allows an amount of power of the battery 30 required for the vehicle 10 to travel to the destination to be ensured if the user withholds using the appliances 60 in response to this notification. The vehicle 10 can therefore more reliably reach the destination.

Modifications

The prediction ECU 70 of the vehicle 10 according to one modification to the first embodiment will now be described.

The notification controller 72, at step S14 illustrated in FIG. 2, may notify the user of the vehicle 10 of information related to charging facilities that can charge the battery 30. Causing the vehicle 10 to travel toward a charging facility and charging the battery 30 of the vehicle 10 based on this notification can increase the amount of charged power in the battery 30, which allows the vehicle 10 to more reliably reach the destination while using the appliances 60.

### SECOND EMBODIMENT

A prediction ECU 70 of the vehicle 10 according to a second embodiment will now be described. In the following, only differences of the second embodiment from the first embodiment will be described.

The prediction ECU 70 of the present embodiment is configured to, in response to the power usage of the appliances 60 having progressively approached the upper limit of the available range of amounts of surplus power of the battery 30, limit actuation of the appliances 60 and driving of the vehicle 10, thereby allowing the vehicle 10 to more reliably reach the destination.

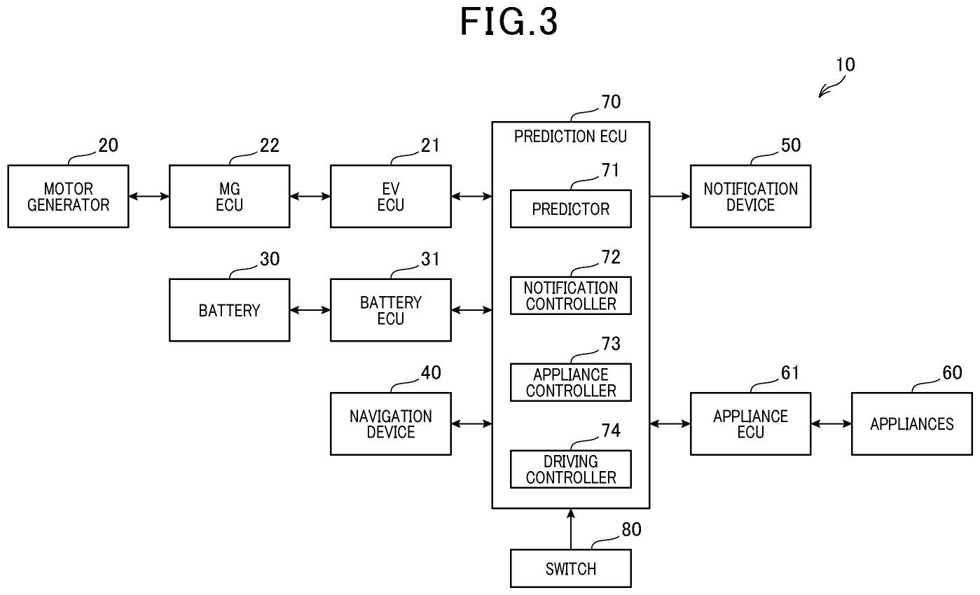

More specifically, as illustrated in FIG. 3, the vehicle 10 further includes a switch 80 that is turned on or off by the user. In the present embodiment, the switch 80 corresponds to a mode switcher. The switch 80 outputs an operation signal to the prediction ECU 70. When the switch 80 is off, the prediction ECU 70 does not limit any one of actuation of the appliance 60 and driving of the vehicle 10 in response to the power usage of the appliances 60 having progressively approached the upper limit of the available range of amounts of surplus power of the battery 30.

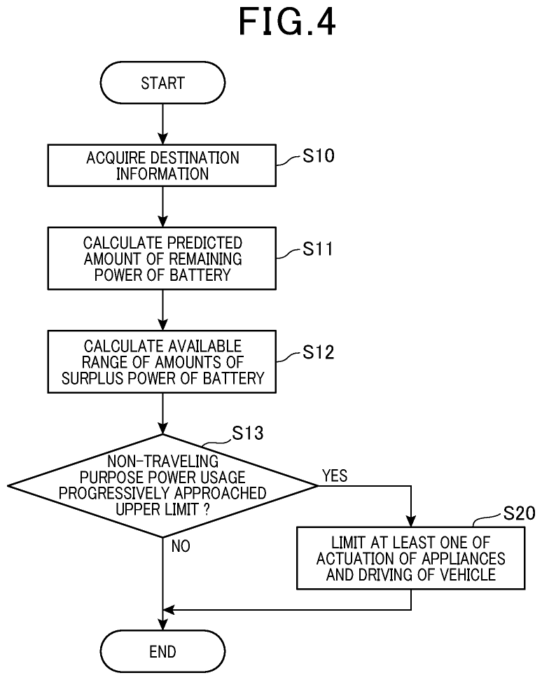

When the switch 80 is on, the prediction ECU 70 performs step S20 illustrated in FIG. 4. That is, if the prediction ECU 70 selects the “YES” branch at step S13, that is, if the non-traveling-purpose power usage has progressively approached the upper limit β of the available range of amounts of surplus power of the battery 30, then at step S20 the prediction ECU 70 limits actuation of the appliance 60 and driving of the vehicle 10. In the configuration of the present embodiment, the prediction ECU 70 further includes an appliance controller 73 and a driving controller 74 as illustrated in FIG. 3 to perform step S20.

The appliance controller 73, at step S20, directs the appliance ECU 61 to limit actuation of the appliances 60. The appliance ECU 61 then changes the operation mode of the appliances 60 to an eco-mode or forces the appliances 60 to stop, which reduces the power consumption of the appliances 60. The driving controller 74, at step S20, directs the EV ECU 21 to limit driving of the vehicle 10. The EV ECU 21 then sets an upper limit of output torques of the motor generator 20, thereby reducing the power usage for driving of the vehicle 10.

In some other embodiments, instead of limiting both actuation of the appliance 60 and driving of the vehicle 10, the prediction ECU 70 may, at step S20, limit either actuation of the appliance 60 or driving of the vehicle 10 in response to the power usage of the appliances 60 having progressively approached the upper limit β of the available range of amounts of surplus power of the battery 30.

The prediction ECU 70 of the vehicle 10 according to the second embodiment set forth above can provide the following additional advantages (5)-(7).

(5) The appliance controller 73 is configured to, in response to the non-traveling-purpose power usage having progressively approached the upper limit β of the available range of amounts of surplus power of the battery 30, change the operation mode of the appliances 60 to the eco-mode or force the appliances 60 to stop, thereby limiting actuation of the appliances 60. This configuration facilitates ensuring an amount of power of the battery 30 required for the vehicle 10 to travel to the destination, which allows the vehicle 10 to more reliably reach the destination.

(6) The appliance controller 73 is configured to, in response to the operation of the switch 80, control the appliances 60 to switch between a first operation mode in which actuation of the appliances 60 is limited and a second operation mode in which actuation of the appliances 60 is not limited. This configuration allows the user to switch the operation modes of the appliances 60 via the operation of the switch 80, which can improve the convenience.

(7) The driving controller 74 is configured to, in response to the non-traveling-purpose power usage having progressively approached the upper limit β of the available range of amounts of surplus power of the battery 30, limit driving of the vehicle 10. This configuration allows some amount of charged power in the battery 30 to be saved by limiting driving of the vehicle 10. Such a saved amount of charged power in the battery becomes available to the appliances 60, which can improve the convenience for the user.

### OTHER EMBODIMENTS

Numerous modifications, alterations, and changes to the above-described embodiments are possible as follows without departing from the scope of the present disclosure.

The notification method of the notification device 50 may be modified as appropriate.

The prediction ECU 70 and its method described in relation to the present disclosure may be implemented by a dedicated computer that is provided by forming a processor and a memory programmed to execute one or more functions embodied by a computer program. Otherwise, the prediction ECU 70 and its method described in relation to the present disclosure may be implemented by a dedicated computer that is provided by forming a processor from one or more dedicated hardware logic circuits. Alternatively, the prediction ECU 70 and its method described in relation to the present disclosure may be implemented by one or more dedicated computers that are formed by a combination of a processor and a memory programmed to execute one or more functions and one or more hardware logic circuits. The computer program may be stored as instructions to be executed by a computer in a computer-readable non-transitory tangible recording medium. The dedicated hardware logic circuit and the hardware logic circuit may be implemented by a digital circuit including a plurality of logic circuits or an analogy circuit.

So far, some exemplary embodiments have been described. However, the present disclosure is not limited thereto. It should be appreciated that various appropriate design modifications made by those skilled in the art are included in the scope of the present disclosure as long as those modifications have the technical features of the present disclosure. The individual components described in the aforementioned exemplary embodiments and layouts, conditions and forms thereof are not limited to the above-described examples and can be modified appropriately. The individual components of the above-described exemplary embodiments can be appropriately combined unless they are technically contradictory.

What is claimed is:

1. A control apparatus for an electric vehicle driven by an electric motor being actuated based on electric power supplied from a battery, the control apparatus comprising:
a predictor configured to calculate a predicted amount of remaining power of the battery that will remain on arrival of the vehicle at a destination; and
a notification controller configured to cause a notifier to provide a notification based on the predicted amount of remaining power of the battery.

2. The control apparatus according to claim 1, wherein
the predictor is configured to calculate the predicted amount of remaining power of the battery based on a predicted steady power consumption that is an amount of power steadily consumed in the vehicle and a predicted amount of traveling-purpose energy that is required for the vehicle to travel to the destination.

3. The control apparatus according to claim 2, wherein
the predictor is configured to calculate an available range of amounts of surplus power of the battery that are available for non-traveling purposes, based on the predicted amount of remaining power of the battery.

4. The control apparatus according to claim 3, wherein
the notification controller is configured to, in response to an amount of non-traveling purpose energy of the battery, which is an amount of energy of the battery used for purposes other than driving the vehicle, having progressively approached an upper limit of the available range of amounts of surplus power of the battery, provide the notification to a user of the vehicle.

5. The control apparatus according to claim 4, wherein
the notification provided to the user of the vehicle includes information related to charging facilities to charge the battery of the vehicle.

6. The control apparatus according to claim 4, further comprising an appliance controller configured to, in response to the amount of non-traveling purpose energy of the battery having progressively approached the upper limit of the available range of amounts of surplus power of the battery, limit actuation of appliances that are used for purposes other than driving the vehicle.

7. The control apparatus according to claim 6, wherein
the appliance controller is configured to, in response to the amount of non-traveling purpose energy of the battery having progressively approached the upper limit of the available range of amounts of surplus power of the battery, control the appliances to switch between a first operation mode in which actuation of the appliances is limited and a second operation mode in which actuation of the appliances is not limited, based on operations of a mode switcher installed in the vehicle.

8. The control apparatus according to claim 6, wherein
the appliance controller is configured to force the appliances to stop, thereby limiting actuation of appliances.

9. The control apparatus according to claim 4, further comprising a driving controller configured to, in response to the amount of non-traveling purpose energy of the battery having progressively approached the upper limit of the available range of amounts of surplus power of the battery, limit driving of the vehicle.

10. A control apparatus for an electric vehicle driven by an electric motor being actuated based on electric power supplied from a battery, the control apparatus comprising:
a non-transitory memory storing one or more computer programs; and
a processor executing the one or more computer programs to:
calculate a predicted amount of remaining power of the battery that will remain on arrival of the vehicle at a destination; and
cause a notifier to provide a notification based on the predicted amount of remaining power of the battery.
